(19) United States
(12) Patent Application Publication
(10) Pub. No.: US 2017/0143090 A1
(43) Pub. Date: May 25, 2017

(54) HANDLE ASSEMBLY FOR A CASE

(71) Applicant: Milwaukee Electric Tool Corporation, Brookfield, WI (US)

(72) Inventor: Matthew W. Naiva, Wauwatosa, WI (US)

(21) Appl. No.: 15/361,271

(22) Filed: Nov. 25, 2016

Related U.S. Application Data
(60) Provisional application No. 62/259,859, filed on Nov. 25, 2015.

(51) Int. Cl. A45C 13/26; B25H 3/02; A45C 5/14

(52) U.S. Cl. CPC A45C 13/262; A45C 5/14; B25H 3/02; A45C 2013/267

(57) ABSTRACT

A telescoping handle assembly, a mobile device, and a method of assembling a telescoping handle assembly for a mobile device. The handle assembly may include a first handle section, and a second handle section telescopingly arranged relative to the first handle section. The handle assembly may further include a latch assembly fixed to one of the first handle section and the second handle section and selectively engageable with the other of the first handle section and the second handle section. The latch assembly may include a latch body positioned between the first handle section and the second handle section and a shock-absorbing mount positioned between the latch body and the one of the first handle section and the second handle section.

### CROSS-REFERENCE TO RELATED APPLICATION

This application claims priority to co-pending U.S. Provisional Patent Application No. 62/259,859, filed on Nov. 25, 2015, the entire contents of which is hereby incorporated by reference.

### FIELD

The present invention relates to mobile (e.g., wheeled) devices and, more particularly, to a handle assembly for such devices.

### SUMMARY

Tool storage devices are often used to transport tools and accessories between and around worksites. As such, the devices may include wheels and a telescoping handle assembly to allow for convenient transportation of the tool storage devices. However, durability is a factor because the devices may be used in various terrain and weather conditions on the worksite. Due to these conditions and the generally rugged use, the devices sustain various shocks and impacts that are transmitted from the device (e.g., the wheels) through the telescoping handle assembly. These impacts and shocks can lead to early failure of the mechanism that secures the telescoping handle assembly in an extended position.

In one independent aspect, a telescoping handle assembly for a mobile device, such as a wheeled device, a storage device, etc. may be provided. The handle assembly may generally include a first handle section; a second handle section telescopingly arranged relative to the first handle section; and a latch assembly fixed to one of the first handle section and the second handle section and selectively engageable with the other of the first handle section and the second handle section. The latch assembly may include a latch body positioned between the first handle section and the second handle section, and a shock-absorbing mount positioned between the latch body and the one of the first handle section and the second handle section.

In another independent aspect, a wheeled mobile device may generally include a frame; a wheel assembly supporting the frame; and a telescoping handle assembly including a first handle section, a second handle section telescopingly arranged relative to the first handle section, and a latch assembly fixed to one of the first handle section and the second handle section and selectively engageable with the other of the first handle section and the second handle section. The latch assembly may include a latch body positioned between the first handle section and the second handle section, and a shock-absorbing mount positioned between the latch body and the one of the first handle section and the second handle section.

In yet another independent aspect, a method of assembling a telescoping handle assembly for a mobile device may be provided. The method may generally include fixing a latch body of a latch assembly to one of a first handle section and a second handle section; positioning a shock-absorbing mount between the latch body and the one of the first handle section and the second handle section; and inserting the one of the first handle section and the second handle section into the other of the first handle section and the second handle section in a telescoping arrangement with the latch assembly positioned in the other of the first handle section and the second handle section.

Other independent features and independent aspects of the invention will become apparent by consideration of the following detailed description, claims and accompanying drawings.

### BRIEF DESCRIPTION OF THE DRAWINGS

FIG. 1 is a perspective view of a mobile device, such as a wheeled storage device (e.g., a portable rolling tool bag).

FIG. 2 is an enlarged exploded view of a handle assembly for the device shown in FIG. 1.

FIG. 3 is a perspective view of a latch assembly for the handle assembly shown in FIG. 2.

FIG. 3A is a perspective view of a bushing of the latch assembly shown in FIG. 3

FIG. 4 is an enlarged cross-sectional view of the handle assembly of FIG. 2 taken generally along line 4-4 in FIG. 1.

FIG. 5 is an enlarged cross-sectional view of the handle assembly of FIG. 2 taken generally along line 5-5 in FIG. 1.

FIG. 6 is a perspective view of a prior art latch assembly.

### DETAILED DESCRIPTION

Before any independent embodiments of the invention are explained in detail, it is to be understood that the invention is not limited in its application to the details of construction and the arrangement of components set forth in the following description or illustrated in the following drawings. The invention is capable of other independent embodiments and of being practiced or of being carried out in various ways. Also, it is to be understood that the phraseology and terminology used herein is for the purpose of description and should not be regarded as limiting.

Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof.

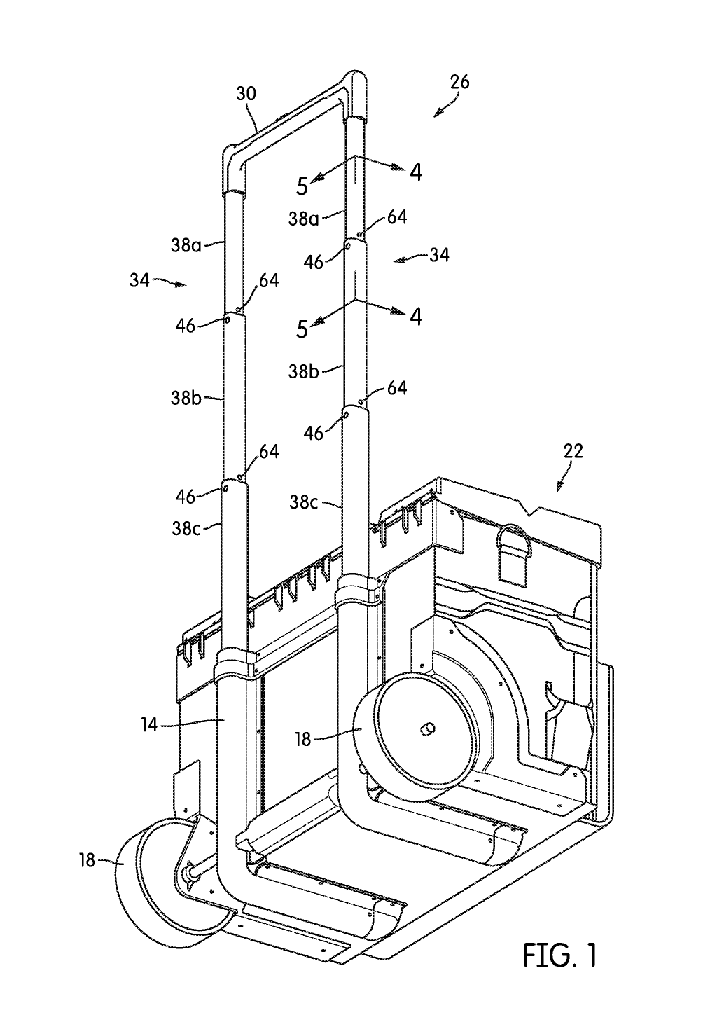

FIG. 1 illustrates a mobile device 10, such as a portable rolling tool bag, movable between and around various locations (e.g., work sites, construction sites, garages, etc.). Exemplary devices are shown and described in U.S. Patent Application Publication No. 2016/0023349, filed Jul. 17, 2015, the entire contents of which is hereby incorporated by reference. In other constructions (not shown), the device 10 may include a tool box, a storage device, a suitcase, a trolley, a dolly, a hand truck, a cart, a wheel barrow, a stroller, a wheel chair, a bed, a table, etc.

The device 10 generally includes a frame 14 supported by one or more wheels 18. As a tool bag, the illustrated device 10 also includes a body 22 defining a storage compartment (not shown), capable of supporting and storing tools, accessories, materials, etc., in an organized manner. A handle assembly 26 is connected to the frame 14 and facilitates maneuvering of the device 10.

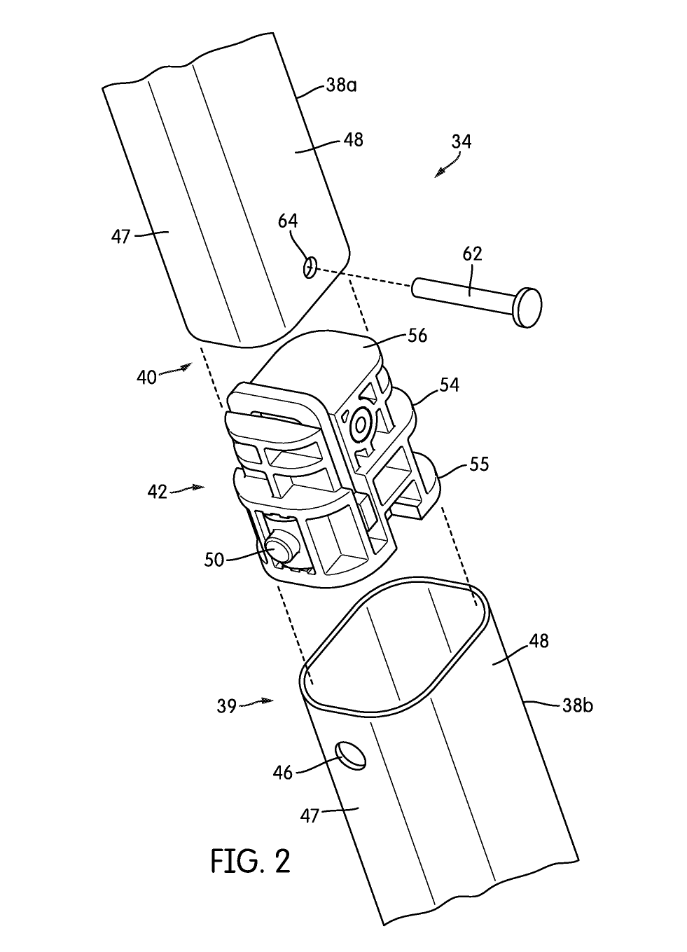

The handle assembly 26 includes a handle member 30 connected to an end of one or more support arms 34 (two in the illustrated construction) adjustably supported by the frame 14. Each support arm 34 includes a number of telescoping arm sections 38a, 38b . . . 38n (three in the illustrated construction). The arm sections 38a-38c are adjustable between an extended position (see FIGS. 1-2) and a retracted position (not shown) to adjust the position of the handle member 30 relative to the frame 14 and the body 22.

Each arm section 38 is an elongated hollow member with a substantially uniform cross-section extending along its length. Each outer arm section (e.g., the arm section 38b) has a cross-section sized to slidingly receive an associated inner arm section (e.g., the arm section 38a) having a relatively smaller concentric cross-section. In the illustrated embodiment, each arm section 38 has a generally rectangular cross-section defined by a pair of short walls 47 and a pair of long walls 48. In other embodiments (not shown), the arm sections 38 may have any shape cross-section with corresponding walls.

With reference to FIGS. 1-2, a latch assembly 42 is provided between adjacent arm sections 38 to selectively and releasably hold the arm sections 38 in the extended position. In the illustrated construction, each outer arm section (e.g., the arm section 38b) defines a recess (e.g., an opening 46) proximate its upper end 39, and each inner arm section (e.g., the arm section 38a) supports a projection 50 proximate its lower end 40. Each projection 50 is selectively engageable in an associated opening 46 to hold the adjacent arm sections (e.g., the arm sections 38a, 38b) in a selected relative position. In the illustrated embodiment, the opening 46 arranged to receive the projection 50 is defined in one of the short walls 47.

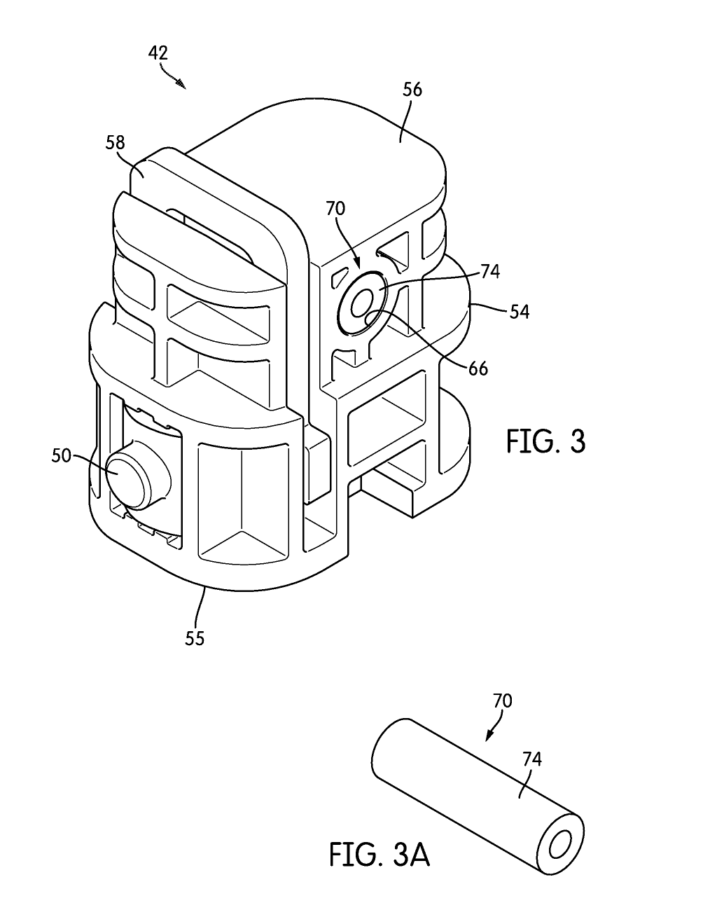

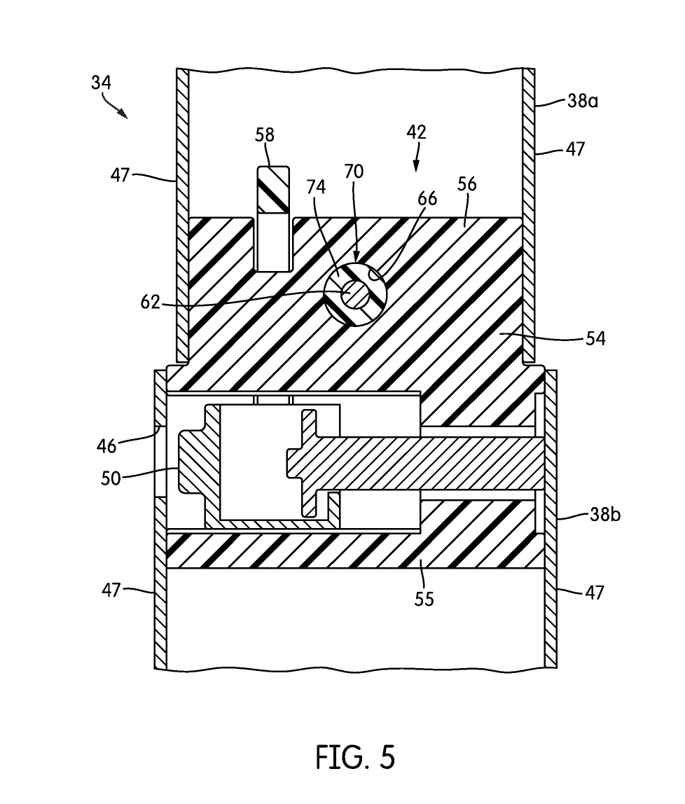

Each projection 50 (see FIG. 3) is movably supported on a lower portion 55 of a latch body 54. The lower portion 55 of the latch body 54 is sized to be slidingly received in the outer arm section 38 (e.g., the arm section 38b) and is too large to be received in the inner arm section 38 (e.g., the arm section 38a). An actuating member 58 is operable to move the projection 50 relative to the body 54 between a projected, latching position (see FIG. 3) and a retracted, release position (see FIG. 5). An actuator (not shown) is operable by the user to retract and disengage each projection 50 from its associated recess 46 so that the arm sections 38 can be retracted and the handle member 30 lowered.

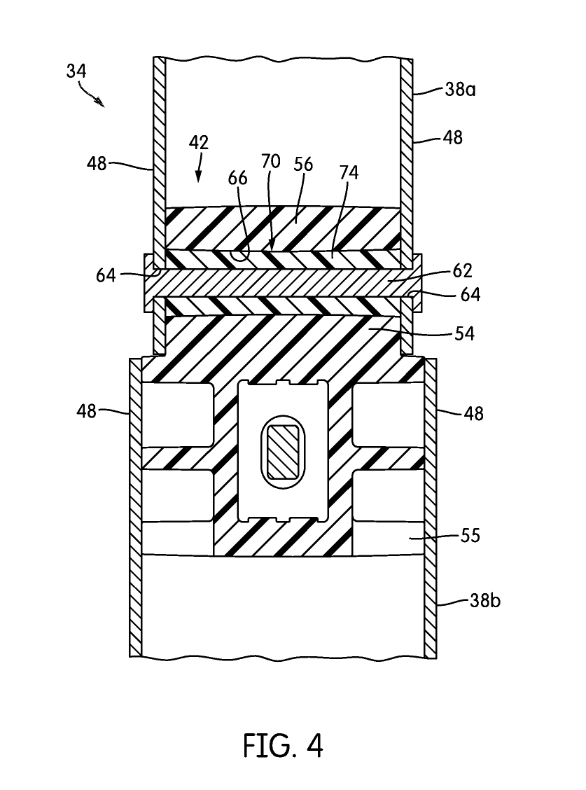

The body 54 is fixed to the arm section (e.g., the arm section 38a), for example, by a rivet 62 (FIGS. 2 and 4), or a similar fastener, such as a pin, etc. In the illustrated construction, the rivet 62 extends through a pair of openings 64 defined in the long walls 48 of the arm section 38 adjacent the lower end 40 of the arm section 38 and an opening 66 in an upper portion 56 of the body 54 aligned with the openings 64 (as shown in FIG. 4). In the illustrated embodiment, one end of the rivet 62 has a pre-formed head and the other end of the rivet 62 is deformed to secure the rivet 62 from being axially removed from the opening 66 in the body 54.

The upper portion 56 of the body 54 is sized to be received in the lower end 40 of the inner arm section 38 (e.g., the arm section 38a), as shown in FIGS. 4-5. The lower portion 55 of the body 54 inhibits insertion of the upper portion 56 of the body 54 into the arm section 38 to a position in which the openings 64 in the long walls 48 do not align with the opening 66 in the body 54.

A similar handle assembly including a latch assembly is illustrated and described in U.S. Pat. No. 6,339,863, issued Jan. 22, 2002, and in U.S. Pat. No. 6,619,448, issued Sep. 16, 2003, the entire contents of both of which are hereby incorporated by reference.

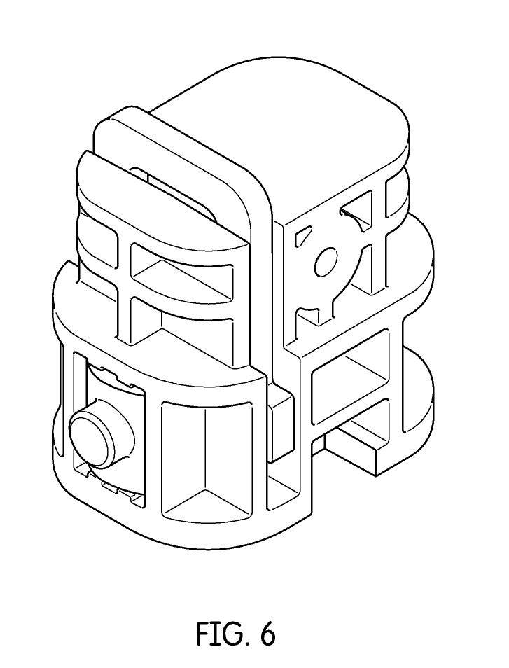

In existing handle assemblies, a failure mode is a fracture around the rivet which causes the handle assembly to fail at 17 to 22 miles in a fatigue cyclic loading “life test”. Such failure is likely to occur even with improved materials, geometry of an existing latch assembly (see FIG. 6).

As shown in FIGS. 2-5, the illustrated latch assembly 42 incorporates a shock-absorbing mount 70 (FIG. 3A) operable to absorb, dampen, limit, reduce, etc. a shock or impact between the frame 14 and the handle member 30 (e.g., between the body 54 and the walls 47, 48 of the adjacent arm section 38). The mount 70 may increase or contribute to an increase in the life, strength, durability, etc. of the handle assembly 26 to, for example, at least 30 miles or more in the fatigue cyclic loading “life test”.

In the illustrated construction, the mount 70 includes a bushing 74 received in the opening 66 and is positioned between the body 54 and the rivet 62. The bushing 74 is formed of shock-absorbing material, such as, for example, urethane (e.g., thermoplastic polyurethane (TPU)), soft plastic, rubber, etc. The material, material characteristics, structure, etc. of the bushing 74 can be adjusted based on, for example, the desired shock-absorbing characteristics.

As illustrated, the bushing 74 is formed as a discrete or separate part and is inserted into the opening 66. In other constructions (not shown), the bushing 74 may be formed with the body 54, for example, in a multi-shot molding process for the body 54. After the bushing 74 is assembled with the body 54, the rivet 62 is inserted.

In operation with the illustrated mount 70, an impact or shock on the device 10 (e.g., on the wheels 18 as the device 10 is rolled across an uneven surface) is transmitted through the frame 14 to the outer arm section (e.g., the arm section 38b), through the walls 47, 48 of the arm section 38b to the body 54. The shock is absorbed or dampened by the bushing 74 before reaching the rivet 62 and, through the rivet 62, the inner arm section (e.g., the arm section 38a) and the handle member 30. An impact or shock on the handle member 30 is likewise absorbed or dampened by the bushing 74 before reaching the walls 47, 48 of the outer arm section 38b. Providing a mount 70 between each of the adjacent arm sections 38 sequentially reduces the magnitude of the impact or shock as it passes through each of the mounts 70.

In other constructions (not shown), in addition to or as an alternative to the illustrated mount 70, a shock-absorbing mount may be provided at one or more other locations between components in the force-transmitting path between the frame 14 and the handle member 30. For example, a shock-absorbing bushing, plate, other structure, etc., may be provided between the long walls 48 of the outer arm section 38b and the end of the rivet 62. In another example, a shock-absorbing mount may be provided between the frame 14 and the adjacent arm section 38c.

In the illustrated construction, the mount 70 has the form of the hollow cylindrical (e.g., tubular) bushing 74 received in the circular opening 66 and receiving the cylindrical rivet 62. In other constructions, the mount 70 may have a different form factor. For example, with a square or rectangular pin (not shown), the mount 70 may include a pad (e.g., a flat isolation pad) engaging between the pin and the associated support structure (e.g., the opening in the latch body, the opening in the wall of the arm section, etc.).

In the illustrated construction, a shock-absorbing mount 70 is provided between each adjacent arm section 38 of each support arm 34 of the handle assembly 26. Accordingly, each additional connection and corresponding mount 70 increases the impact or shock reduction capability. In other constructions (not shown), a shock-absorbing mount 70 may be provided between only selected adjacent arm sections (e.g., between only the arm sections 38b, 38c closest to the frame 14).

One or more independent features and/or independent advantages of the invention may be set forth in the claims.

1. A telescoping handle assembly for a mobile device, the handle assembly comprising:
a first handle section;
a second handle section telescopingly arranged relative to the first handle section; and
a latch assembly fixed to one of the first handle section and the second handle section and selectively engageable with the other of the first handle section and the second handle section, the latch assembly including
a latch body positioned between the first handle section and the second handle section, and
a shock-absorbing mount positioned between the latch body and the one of the first handle section and the second handle section.

2. The handle assembly of claim 1, wherein the latch body defines a body opening, and wherein the shock-absorbing mount includes a cylindrical bushing received in the opening.

3. The handle assembly of claim 1, further comprising a fastener arranged to couple the latch assembly to the one of the first handle section and the second handle section.

4. The handle assembly of claim 3, wherein the shock-absorbing mount is positioned between the fastener and the latch body such that the fastener does not contact the latch body.

5. The handle assembly of claim 4, wherein the shock-absorbing mount includes a cylindrical bushing extending through the latch body and arranged to receive the fastener, wherein the one of the first handle section and the second handle section includes a wall defining a wall opening, and wherein the fastener extends through the opening to couple the latch assembly to the one of the first handle section and the second handle section.

6. The handle assembly of claim 1, wherein the first handle section includes a first elongated hollow member with a first cross-section and the second handle section includes a second elongated hollow member with a second cross-section, wherein the first cross-section is smaller than the second cross-section, and wherein the first handle section is slidingly received within the second handle section.

7. The handle assembly of claim 6, wherein the latch body is partially received in the first handle section, wherein the first handle assembly includes opposing walls, wherein the latch body defines a body opening, wherein a fastener extends through the opposing walls of the first handle section and the body opening to couple the latch assembly to the first handle section, and wherein the shock-absorbing mount is positioned in the body opening of the latch body between the fastener and the latch body.

8. The handle assembly of claim 1, wherein the shock-absorbing mount is made of thermoplastic polyurethane.

9. A wheeled mobile device comprising:
a frame;
a wheel assembly supporting the frame; and
a telescoping handle assembly including
a first handle section,
a second handle section telescopingly arranged relative to the first handle section, and
a latch assembly fixed to one of the first handle section and the second handle section and selectively engageable with the other of the first handle section and the second handle section, the latch assembly including
a latch body positioned between the first handle section and the second handle section, and
a shock-absorbing mount positioned between the latch body and the one of the first handle section and the second handle section.

10. The mobile device of claim 9, wherein the latch body defines a body opening, and wherein the shock-absorbing mount includes a cylindrical bushing received in the body opening.

11. The mobile device of claim 9, further comprising a fastener arranged to couple the latch assembly to the one of the first handle section and the second handle section.

12. The mobile device of claim 11, wherein the shock-absorbing mount is positioned between the fastener and the latch body such that the fastener does not directly contact the latch body.

13. The mobile device of claim 12, wherein the shock-absorbing mount includes a cylindrical bushing extending through the latch body and arranged to receive the fastener, wherein the one of the first handle section and the second handle section includes a wall defining a wall opening, and wherein the fastener extends through the wall opening to couple the latch assembly to the one of the first handle section and the second handle section.

14. The mobile device of claim 9, wherein the first handle section includes a first elongated hollow member with a first cross-section and the second handle section includes a second elongated hollow member with a second cross-section, wherein the first cross-section is smaller than the second cross-section, and wherein the first handle section is slidingly received within the second handle section.

15. The mobile device of claim 14, wherein the latch body is partially received in the first handle section, wherein the first handle section includes opposing walls, wherein the latch body defines a body opening, wherein a fastener extends through the opposing walls and the body opening to couple the latch assembly to the first handle section, and wherein the shock-absorbing mount is positioned within the body opening between the fastener and the latch body.

16. The mobile device of claim 9, wherein the shock-absorbing mount is made of thermoplastic polyurethane.

17. A method of assembling a telescoping handle assembly for a mobile device, the method comprising:
fixing a latch body of a latch assembly to one of a first handle section and a second handle section;
positioning a shock-absorbing mount between the latch body and the one of the first handle section and the second handle section; and
inserting the one of the first handle section and the second handle section into the other of the first handle section and the second handle section in a telescoping arrangement with the latch assembly positioned in the other of the first handle section and the second handle section.

18. The method of claim 17, further comprising:
inserting the shock-absorbing mount within a body opening defined by the latch body; and
extending a fastener through the opening in the latch body to couple the latch body to the one of the first handle section and the second handle section with the shock-absorbing mount positioned between the fastener and the latch body.

19. The method of claim 17, further comprising extending the fastener through openings in opposing walls of the one of the first handle section and the second handle section.

20. The method of claim 17, further comprising forming the shock-absorbing mount from thermoplastic polyurethane.
